(19) United States
(12) Patent Application Publication
(10) Pub. No.: US 2014/0239607 A1
(43) Pub. Date: Aug. 28, 2014

(54) VEHICLE WHEEL AXLE LIFTING DEVICE

(71) Applicant: Chiang-Chuan Wu, Taichung City (TW)

(72) Inventor: Chiang-Chuan Wu, Taichung City (TW)

(21) Appl. No.: 14/354,841

(22) PCT Filed: Nov. 1, 2011
(86) PCT No.: PCT/CN2011/081621

§ 371 Date: Apr. 28, 2014

(51) Int. Cl. B60G 7/02

(52) U.S. Cl. CPC B60G 7/02; B60G 2200/13
USPC 280/124.116

(57) ABSTRACT

A vehicle wheel axle lifting device is provided, including a fixing portion, a cantilever and an urging arm. The cantilever and the urging arm are respectively mounted to the fixing portion, and the cantilever and the urging arm are swingable respectively around different axes so as to allow a first air bag to be disposed between the urging arm and the fixing portion. The first air bag is abutted against the urging arm, and the urging arm is abutted against the cantilever, so the vehicle wheel axle lifting device is energy-saving and easy to maintain, assemble and disassemble.

### BACKGROUND OF THE INVENTION

1. Field of the Invention

The present invention relates to a vehicle wheel axle lifting device, especially to the vehicle wheel axle lifting device used in load-carrying vehicles.

2. Description of the Prior Art

In the conventional vehicle wheel axle lifting devices disclosed in TWM404794 and EP0941915, a wheel axle lifting device is mainly composed of two sets of air bags and a gas spring or an oil pressure rod. Users can mount the wheel axle lifting device in their vehicles and operate it to move the wheel axle upward or downward as well as to buffer and absorb shock.

However, there are deficiencies in the above-mentioned inventions. First, as shown in the drawings of the above two inventions, the air bag located in the lower left position is abutted near the swinging axis of the cantilever and restricted by the lever principle. The air bag needs to provide great force to lift the cantilever, so it is difficult to operate. Because the air bag needs to provide greater force, the life expectancy of the air bag may reduce, and the maintenance cost may increase. Second, the air bag located in the left side is disposed under the base vertically. When the air bag is damaged, users have to disassemble the air bag along with the base and then assemble and fix normal air bag along with the base. Therefore, it is not easy to assemble and disassemble, and it is inconvenient to maintain.

The present invention is, therefore, arisen to obviate or at least mitigate the above-mentioned disadvantages.

### SUMMARY OF THE INVENTION

The main object of the present invention is to provide a vehicle wheel axle lifting device which has a stable and energy-saving structure and is easy to maintain.

To achieve the above and other objects, the vehicle wheel axle lifting device of the present invention is provided to be disposed on a vehicle. The vehicle has a body of the vehicle and a wheel axle. The vehicle wheel axle lifting device of the present invention includes a fixing portion, a cantilever, an urging arm, a first air bag and a second air bag.

The fixing portion is provided to be fixedly disposed under the body of the vehicle, and the fixing portion has a supporting portion.

The cantilever is mounted to the fixing portion and swingable upward and downward around a cantilever axis located at the fixing portion, and the cantilever is provided for the wheel axle to dispose thereon.

The urging arm is mounted to the fixing portion and swingable around an abutting axis located at the fixing portion, and the abutting axis and the cantilever axis are parallel to and separated from each other. The urging arm has an abutting portion abutted against the cantilever and the other supporting portion, and the abutting portion is abutted upward against the cantilever.

The first air bag is abutted laterally against and disposed between the two supporting portions, and an end of the second air bag is abutted against the cantilever with the other end abutted against the body of the vehicle.

In the present invention, the first air bag is abutted against the urging arm, and the urging arm is abutted against the cantilever; the wheel axle disposed on the cantilever can be moved upward or downward, wherein, the cantilever axis and the abutting axis extend away from each other, so the present invention is energy-saving; moreover, the first air bag of the present invention is laterally disposed, so it is convenient for users to assemble, disassemble or maintain.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is perspective breakdown drawing of the present invention;

FIG. 3 is a side view of the present invention;

FIGS. 4 and 5 are drawings showing the present invention in use;

FIGS. 6 and 7 are drawings showing another embodiment of the present invention.

### DETAILED DESCRIPTION OF THE PREFERRED EMBODIMENTS

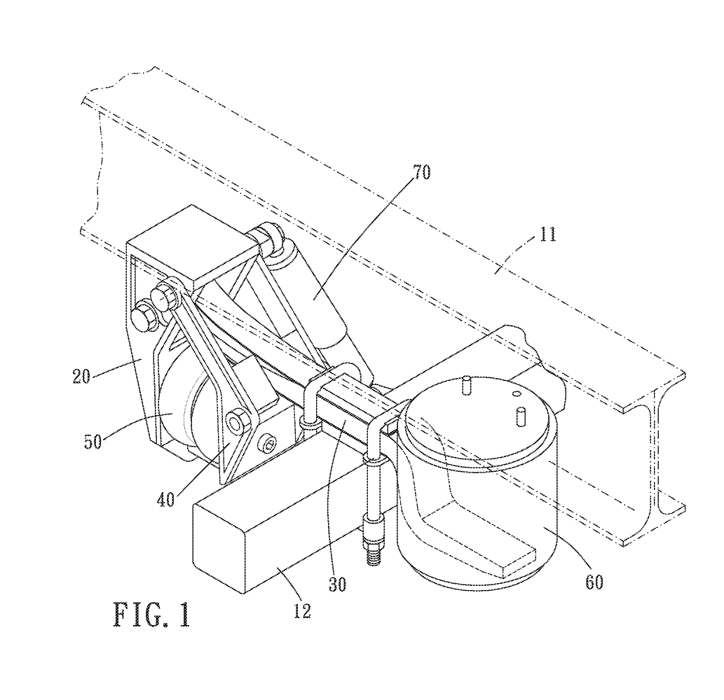

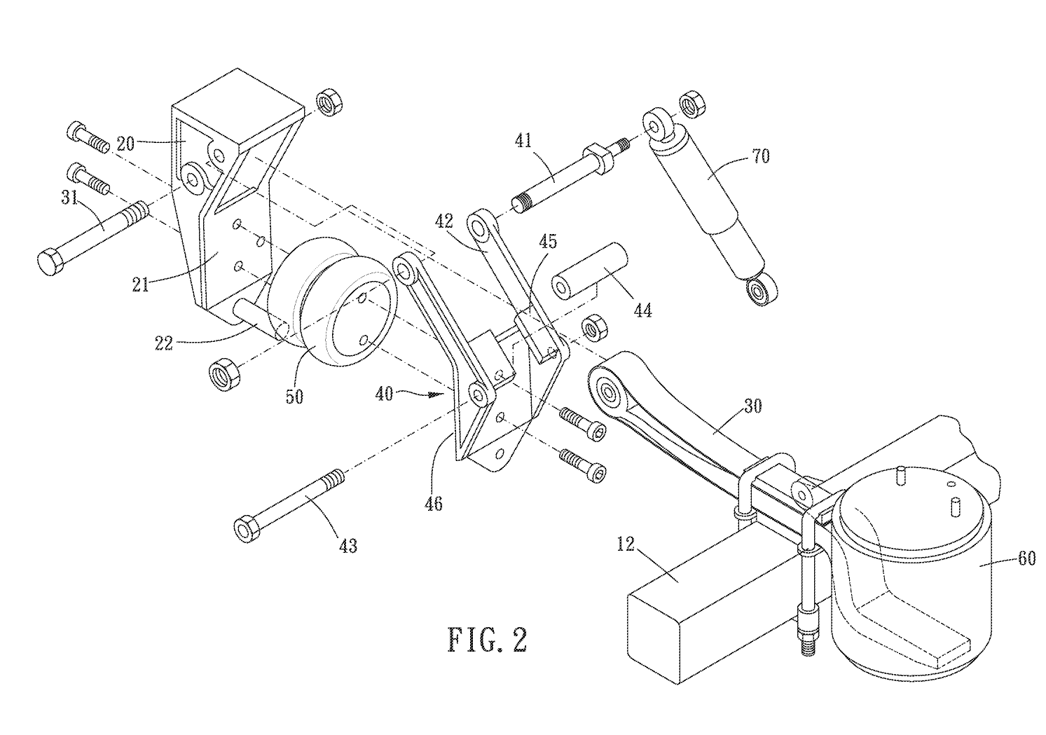

Please refer to FIGS. 1 to 5 for a vehicle wheel axle lifting device of the present invention for being disposed on a vehicle. Generally, a vehicle has a body of the vehicle 11 and at least two wheel axes 12. However, the vehicle wheel axle lifting device of the present invention is disposed between the body of the vehicle 11 and one of the wheel axes 12, and the vehicle mounted with the present invention should has at least one wheel axle 12. The vehicle wheel axle lifting device of the present invention includes a fixing portion 20, a cantilever 30, an urging arm 40, a first air bag 50 and a second air bag 60, and it can further include a bearing rod 70.

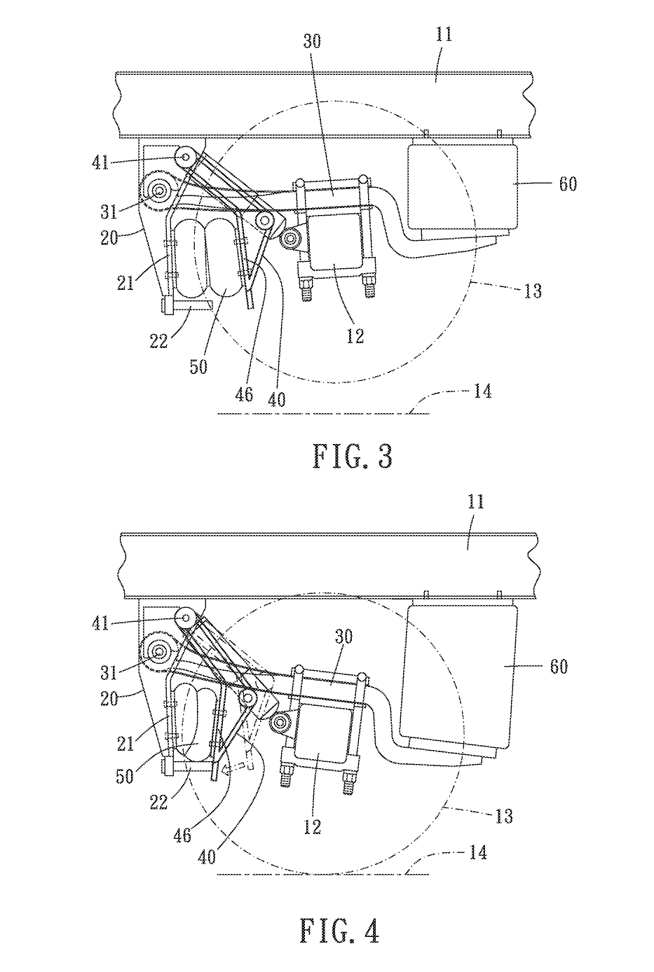

The fixing portion 20 is fixedly disposed under the body of the vehicle 11 and provided for other components of the present invention to mount thereon. The fixing portion 20 has a supporting portion 21, and preferably, as shown in FIG. 3, the supporting portion 21 extends vertically and slightly upward slanted. In this embodiment, the supporting portion 21 further includes a restricting portion 22, and the restricting portion 22 extends forward from the supporting portion 21 and is provided for adjusting a length protrusive from the supporting portion 21. Specifically, the restricting portion 22 may include components such as screw rods and screw nuts to allow users to adjust the restricting portion 22.

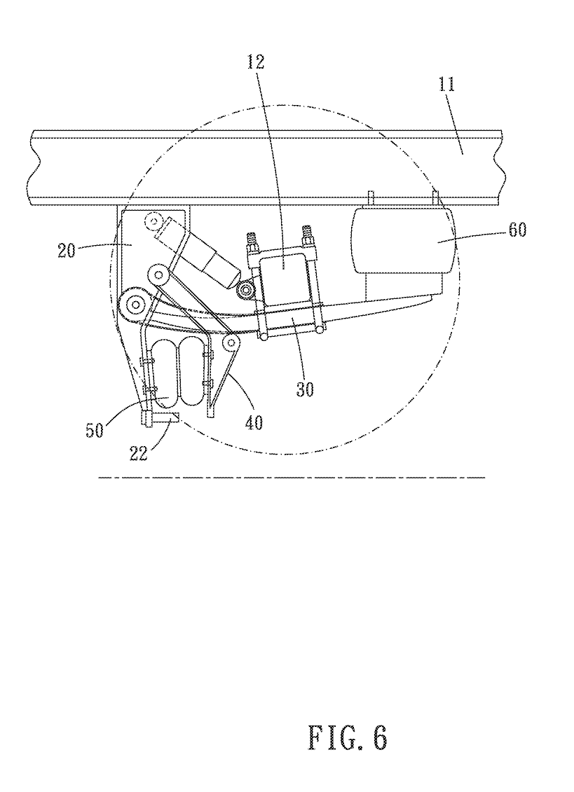

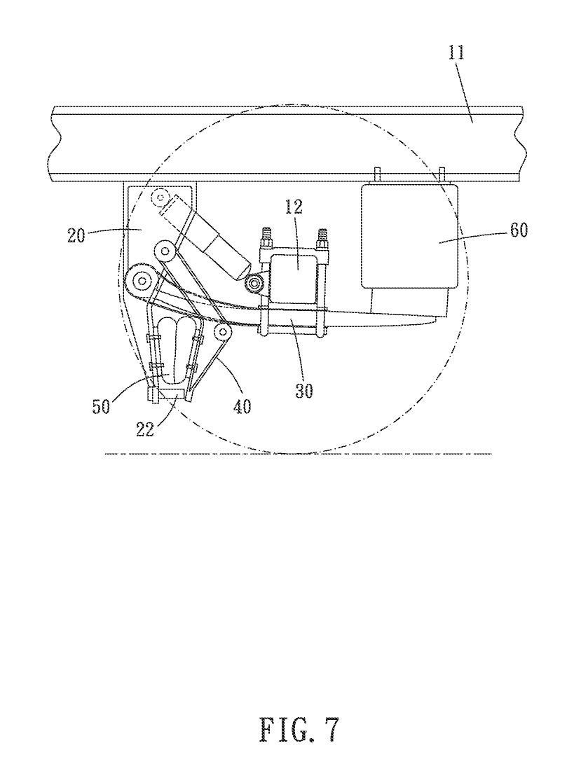

The cantilever 30 is mounted to the fixing portion 20 through an axial rod 31 to make the cantilever 30 swingable around a cantilever axis located at the fixing portion 20. The axial rod 31 extends laterally to make the cantilever 30 swingable upward and downward. The cantilever 30 is provided for the wheel axle 12 of the vehicle to fixedly dispose thereon. In this embodiment, the wheel axle 12 is disposed under the cantilever 30; however, please refer to FIGS. 6 and 7, the wheel axle 12 of the present invention can also be disposed above the cantilever 30; the cantilever 30 may has multiple layers or other similar structures so as to allow the cantilever 30 has functions like buffering or shock absorption.

The urging arm 40 is mounted to the fixing portion 20 through the other axial rod 41 to make the urging arm 40 swingable around an abutting axis located at the fixing portion 20. The abutting axis defined by the axial rod 41 and the cantilever axis defined by the axial rod 31 are parallel to and separated from each other so as to make the urging arm 40 and the cantilever 30 similar to each other and swingable upward and downward. In a preferable embodiment, the abutting axis is located higher than the cantilever axis; moreover, the abutting axis may be disposed far away from the cantilever axis and extends away from the cantilever axis. The urging arm 40 has an abutting portion abutted against the cantilever 30. Specifically, the urging arm 40 has two branch arms 42, and the cantilever 30 is disposed between the two branch arms. The abutting portion includes a rod body 43 disposed through and connected to the two branch arms, and the abutting portion has a rolling column 44. The rolling column 44 is disposed around the rod body 43 and rollable. The abutting portion is abutted against the cantilever 30 by the rolling column 44 from the downside of the cantilever 30 so as to allow the urging arm 40 to abut against and support the cantilever 30. In addition, the two branch arms 42 respectively have a protruding rib 45. The two protruding ribs 45 are respectively abutted against the cantilever 30 to prevent the cantilever 30 from swaying between the two branch arms 42. The urging arm 40 further has a supporting portion 46. Specifically, the supporting portion 46 of the urging arm 40 is formed by a plate body connected between the two branch arms 42, and a free end of the urging arm 40 disposed under the abutting portion corresponds to the supporting portion 21 of the fixing portion 20. In the preferable embodiment of the present invention, the abutting portion of the urging arm 40 is disposed between the abutting axis and the supporting portion 46 of the urging arm 40. The urging arm 40 extends from the abutting axis to the abutting portion to be downward slanted and tilted relative to the supporting portion 46 of the urging arm 40. In other words, the two branch arms 42 of the urging arm 40 are slanted downward toward the abutting portion and tilted relative to the supporting portion 46 of the urging arm 40.

The first air bag 50 is laterally abutted against and disposed between the two supporting portions 21, 46, and “laterally” means that the first air bag 50 extends substantially levelly; however, the first air bag 50 is pressed by the two supporting portions 21, 46, so it may be slightly slanted. To prevent the first air bag 50 from slanting, the abutting axis defined by the axial rod 41 may be located right above the first air bag 50.

An end of the second air bag 60 is abutted against the cantilever 30, and the other end is abutted against the body of the vehicle 11. More specifically, the second air bag 60 is vertically abutted against the free end of the cantilever 30 so as to allow the wheel axle 12 to be disposed between the fixing portion 20 and the second air bag 60.

The bearing rod 70 is provided for being connected between the wheel axle 12 and the fixing portion 20. Specifically, the bearing rod 70 may be provided with a gas spring or an oil pressure rod, so when the wheel axle 12 moves with the cantilever 30, the bearing rod 70 may provide functions like buffering and/or damping.

By using the above-mentioned device, the present invention can help users to move the wheel axle 12 upward or downward and serve buffering function.

Please refer to FIG. 3, when users inflate the first air bag 50, the first air bag 50 presses and abuts against the urging arm 40 so as to allow the urging arm 40 to push the cantilever 30 to make the cantilever swing upward; and the second air bag 60 disposed at the free end of the cantilever 30 would deflate and contract to lift the wheel axle 12.

Please refer to FIG. 4. When users want to use the wheel axle 12, they can deflate the first air bag 50 and inflate the second air bag 60. Then, the cantilever 30 would sway downward in an opposite direction of the movement shown in FIG. 3 and drives the wheel axle 12 to move downward so as to allow a tire 13 disposed on the wheel axle 12 to touch the ground 14.

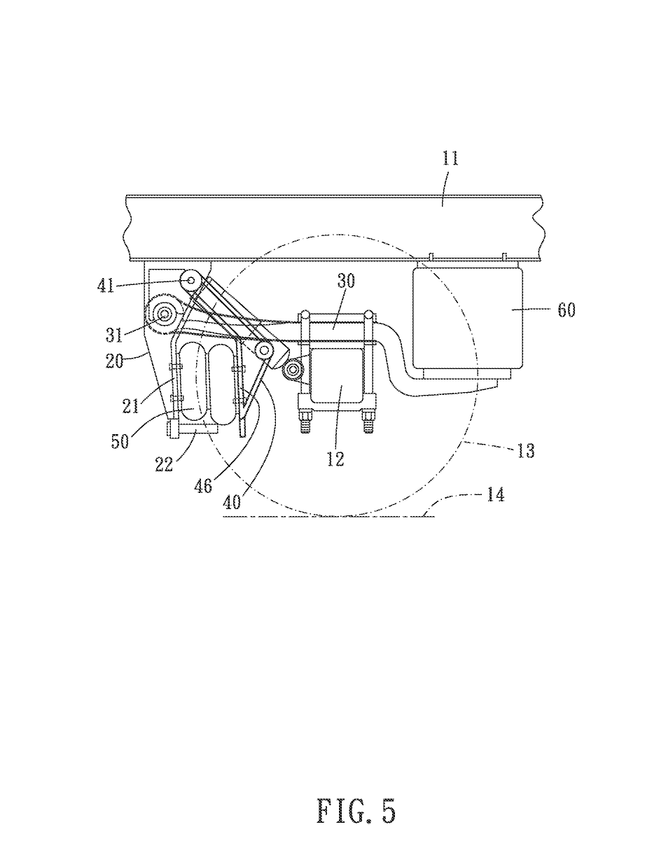

Please refer to FIG. 5. When the vehicle is loaded with a heavy object and pressed by the heavy object, the body of the vehicle 11 would sink and make the wheel axle 12 move relatively upward so as to allow the cantilever 30 to swing upward and press the second air bag 60. When the wheel axle 12 and the cantilever 30 move and swing, the first air bag 50 and the second air bag 60 can provide effects such as buffering and damping.

Wherein, please refer to FIG. 5, when the cantilever 30 swings downward, the restricting portion 22 may be abutted against the supporting portion 46 of the urging arm 40. The restricting portion 22 is adjustable to keep an adjustable smallest compression distance disposed between the two supporting portions 21, 46; therefore, the two supporting portions 21, 46 will not get too close to each other, and the first air bag 50 will not be compressed and damaged. At the same time, the cantilever 30 can be prevented from swing downward excessively, and the second air bag 60 will not expand and deform excessively. Therefore, the present invention can properly protect the first air bag 50 and the second air bag 60 to maintain the life expectancy of the first air bag 50 and the second air bag 60. In other possible embodiments of the present invention, the restricting portion 22 can be disposed on the supporting portion 46 of the urging arm 40 and provide the same functions.

Given the above, the urging arm 40 of the present invention is swingable around the abutting axis, and the abutting axis and the cantilever axis extend away from each other so as to use a force provided by the first air bag 50 to push the cantilever 30 to swing. Preferably, the urging arm 40 is abutted upward against the cantilever 30 to approach the wheel axle 12 so as to allow the vehicle wheel axle lifting device to have better structure and to lift the cantilever 30 and the wheel axle 12 with less force.

Second, in the present invention, the first air bag 50 is laterally disposed to allow users to assemble or disassemble the first air bag 50 easily, and it is convenient for users to maintain the present invention.

Furthermore, in the present invention, the urging arm 40 is provided for pushing the first air bag 50 to allow the first air bag 50 to be pressed stably during the pressing process, and problems like tilt or deformation can be prevented. In addition, the urging arm 40 has a downward slanted structure so as to allow the urging arm 40 to clip and press the first air bag 50 properly and stably. The situation like compression, tilt or deformation of the first air bag 50 may decrease and the life expectancy of the first air bag 50 will largely increase.

In addition, the urging arm 40 of the present invention may be abutted against the cantilever 30 through the protruding rib 45 to prevent the cantilever 30 and the wheel axle 12 from swinging randomly due to torque function when the vehicle takes a turn. The structural stability of the present invention is increased, and the life expectancy of the present invention is further increased.

Given the above-mentioned embodiments, the vehicle wheel axle lifting device of the present invention has special structure and connections of components, so the structural stability and life expectancy of the vehicle wheel axle lifting device is largely increased, and it is easy to assemble, disassemble and maintain.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vehicle wheel axle lifting device used for being adapted for a vehicle which has a car body and a wheel axle, including:
a fixing portion, being provided for being fixedly disposed under the car body, the fixing portion having a supporting portion;
a cantilever, being mounted to the fixing portion and swingable upward and downward around a cantilever axis located at the fixing portion, the cantilever being provided for the wheel axle to dispose thereon;
an urging arm, being mounted to the fixing portion and swingable around an abutting axis located at the fixing portion, the abutting axis and the cantilever axis being parallel to and separated from each other, the urging arm having an abutting portion abutted against the cantilever and a supporting portion, the abutting portion being abutted upward against the cantilever;
a first air bag, being laterally abutted and disposed between the two supporting portions;
a second air bag, having an end abutted against the cantilever, the other end abutted against the car body.

2. The vehicle wheel axle lifting device of claim 1, wherein the abutting axis is located higher than the cantilever axis.

3. The vehicle wheel axle lifting device of claim 1, wherein the abutting axis is located right above the first air bag.

4. The vehicle wheel axle lifting device of claim 2, wherein the abutting axis and the cantilever axis extend away from each other.

5. The vehicle wheel axle lifting device of claim 1, wherein the abutting portion of the urging arm is disposed between the abutting axis and the supporting portion of the urging arm, and the urging arm extends from the abutting axis to the abutting portion to be downward slanted and is tilted relative to the supporting portion of the urging arm.

6. The vehicle wheel axle lifting device of claim 1, wherein the supporting portion of the fixing portion is slightly upward slanted.

7. The vehicle wheel axle lifting device of claim 1, wherein the urging arm has two branch arms, the abutting portion is connected between the two branch arms, the cantilever is disposed between the two branch arms, each branch arm has a protruding rib, and the two protruding ribs are respectively abutted against the cantilever.

8. The vehicle wheel axle lifting device of claim 1, wherein one of the two supporting portions has a restricting portion, and the other supporting portion is selectively abutted against the restricting portion to keep a smallest compression distance between the two supporting portions.

9. The vehicle wheel axle lifting device of claim 8, wherein the restricting portion is adjustable to allow the smallest compression distance to be adjusted.

10. The vehicle wheel axle lifting device of claim 1, wherein the abutting portion is abutted upwardly against the cantilever from the downside of the cantilever, the abutting portion has a rollable rolling column, and the rolling column is abutted against the cantilever.
